(19) United States
(12) Patent Application Publication
(10) Pub. No.: US 2016/0240116 A1
(43) Pub. Date: Aug. 18, 2016

(54) Decorative Finial Banner Display System

(71) Applicant: James Knox Nash, Gallatin, TN (US)

(72) Inventor: James Knox Nash, Gallatin, TN (US)

(21) Appl. No.: 14/624,662

(22) Filed: Feb. 18, 2015

(51) Int. Cl. G09F 17/00; F16M 13/02

(52) U.S. Cl. CPC G09F 17/00; F16M 13/02

(57) ABSTRACT

A Decorative Finial Banner Display System comprising of a decorative finial that connects to a banner rod that in turn attaches to a mounting bracket secured to a vertical surface. Mounting bracket can have one or more banner rod pins for single or multiple banner and decorative finial displays on a slightly above horizontal angle to assist banner detangling during high winds. A decorative finial adapter mount is also available to consumers, to allow display of the decorative finial, with consumer's existing banner and rod.

Decorative Finial Banner Display System is a new and innovative way to turn a traditional two dimensional banner display into a three dimensional, personalized display! (ref. FIG. 1)

With the introduction of a quick change, event specific Decorative Finial (ref. FIG. 13) to match the event's celebration banner, the consumer is able to personalize the banner of choice in seconds with a broad array of team logo, sports affiliation, holiday design or virtually any other type of art to add a visually distinguishable and appealing expression for their favorite event!

The Decorative Finial Banner Display System can be displayed virtually anywhere because of the many ways it mounts. With the Vertical Surface Brackets supplied with the complete system, the consumer receives 2 brackets (ref. FIG. 7, 9) that mount almost anywhere he or she can bolt, screw or stick, using the very high bond adhesive backing. (ref FIG. 8, 10)

The various uses of this product include, but are not limited to homes (inside and out), RV's (at tailgating events, ref. FIG. 8, 10) and a wide variety of retail business, restaurants (sports bars) and sports venues (stadiums).

The Decorative Finial Banner Display System offers a Decorative Finial Adapter Mount so the eye catching Decorative Finial designs can be adapted to a consumers existing dowel rod, to enhance the look of their banner. (ref. FIG. 5)

Construction materials utilized to make the Decorative Finial Banner Display System can vary from plastic, wood, fibers, ferrous and non-ferrous alloys or a combination of all of these. The overall size and weight of the banner and Decorative Finial will determine final material used for the various applications.

### BRIEF DESCRIPTION OF DRAWINGS

FIG. 1 is a perspective view illustrating the invention, comprising of a plurality of display components.

FIG. 2 is a an exploded view of the invention, comprising of three major components, but not limited to these three components only, (ref. FIG. 12) with a mechanical fastener illustrated as an example only.

FIG. 3 and FIG. 4 are schematic views respectively representing a decorative finial display system in the single banner display view as well as in the two or more banner display view, these views illustrating the invention.

FIG. 5 is a parts and assembly view comprising of two decorative finial components utilized with consumer's existing banner rod.

FIG. 6 is schematics views respectively representing a decorative finial adapter mount system, these views illustrating the invention.

FIG. 7 through FIG. 14 illustrate parts and assembly views of the invention.

Decorative Finial Banner Display System Detailed Description of Drawings:

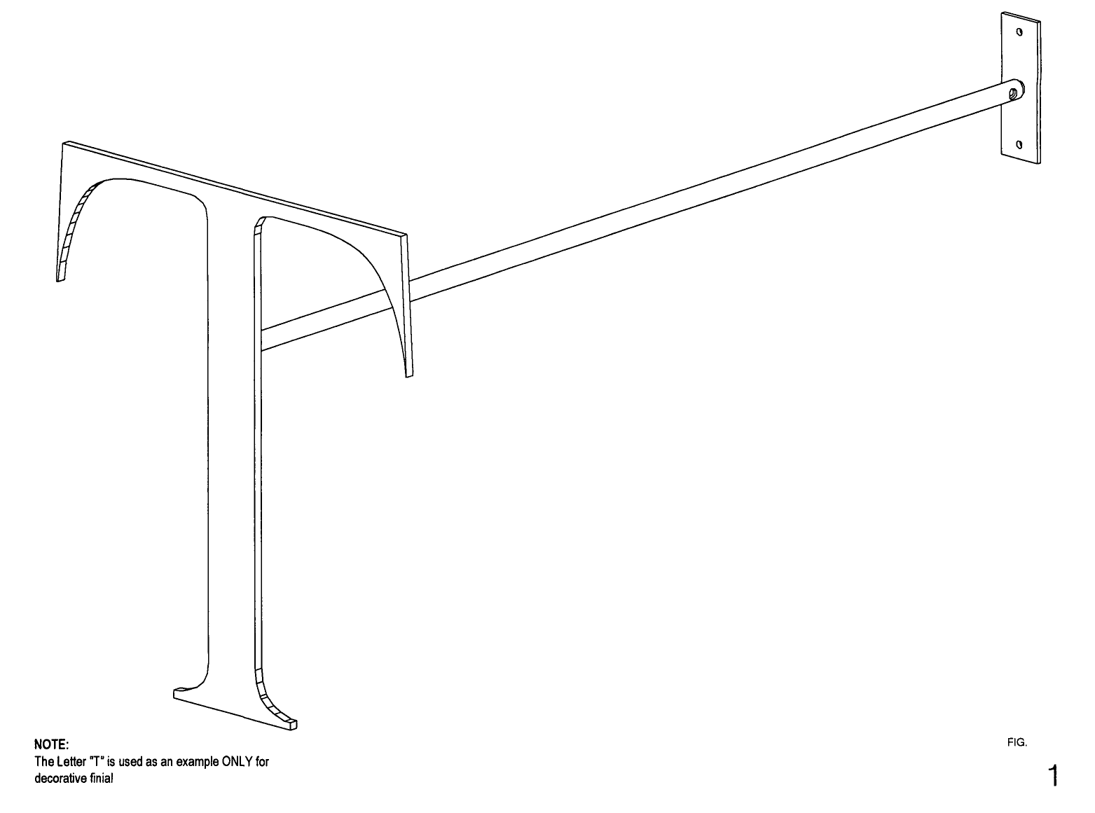

FIG. 1 Decorative Finial Banner Display System, shown as a perspective view of the assembled, single banner display system.

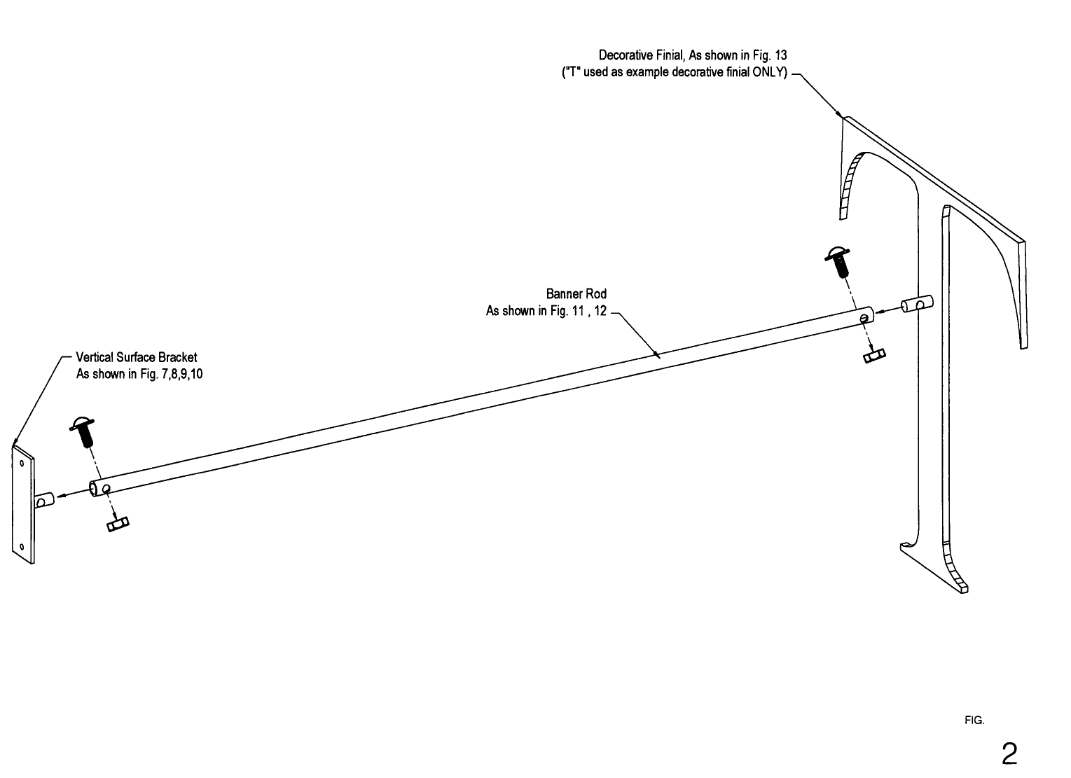

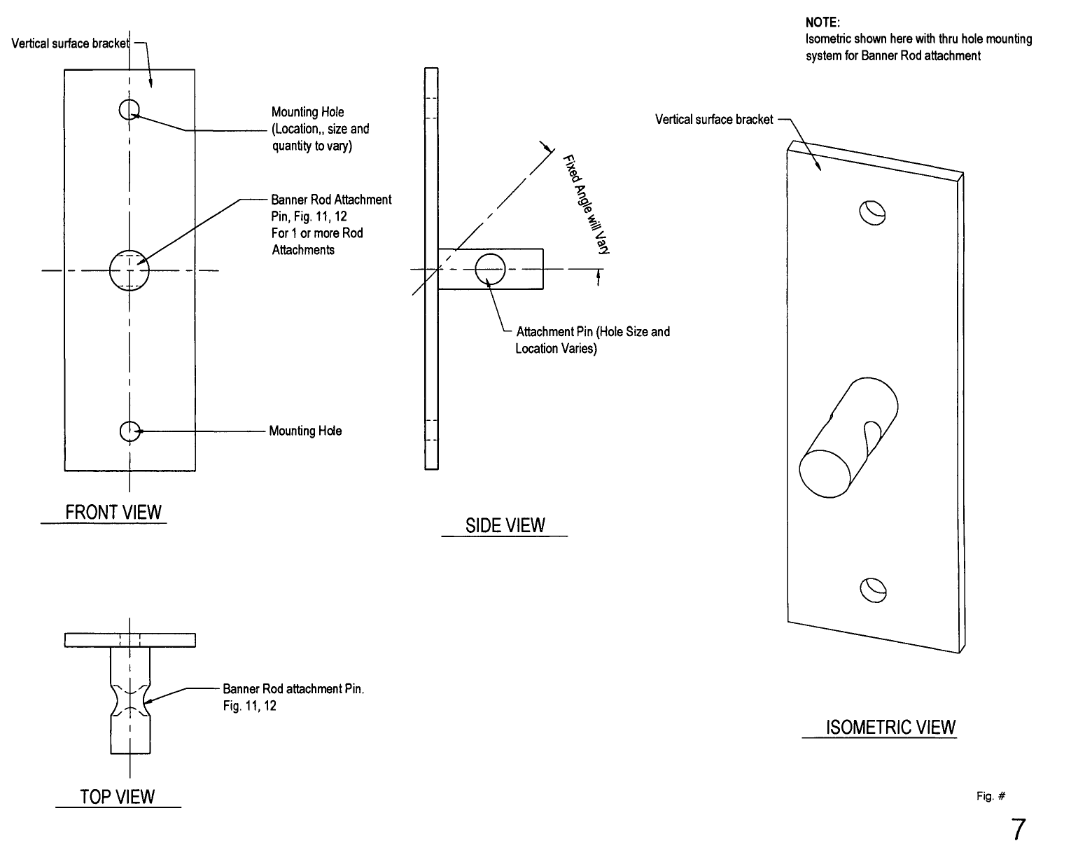

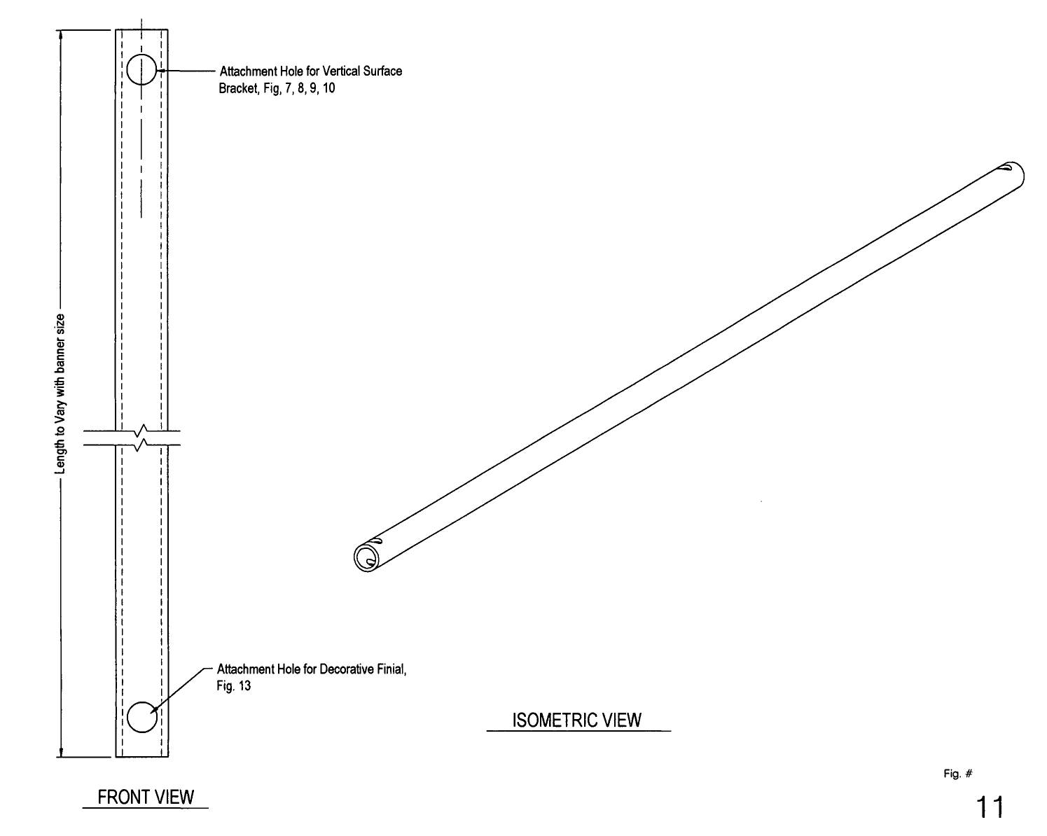

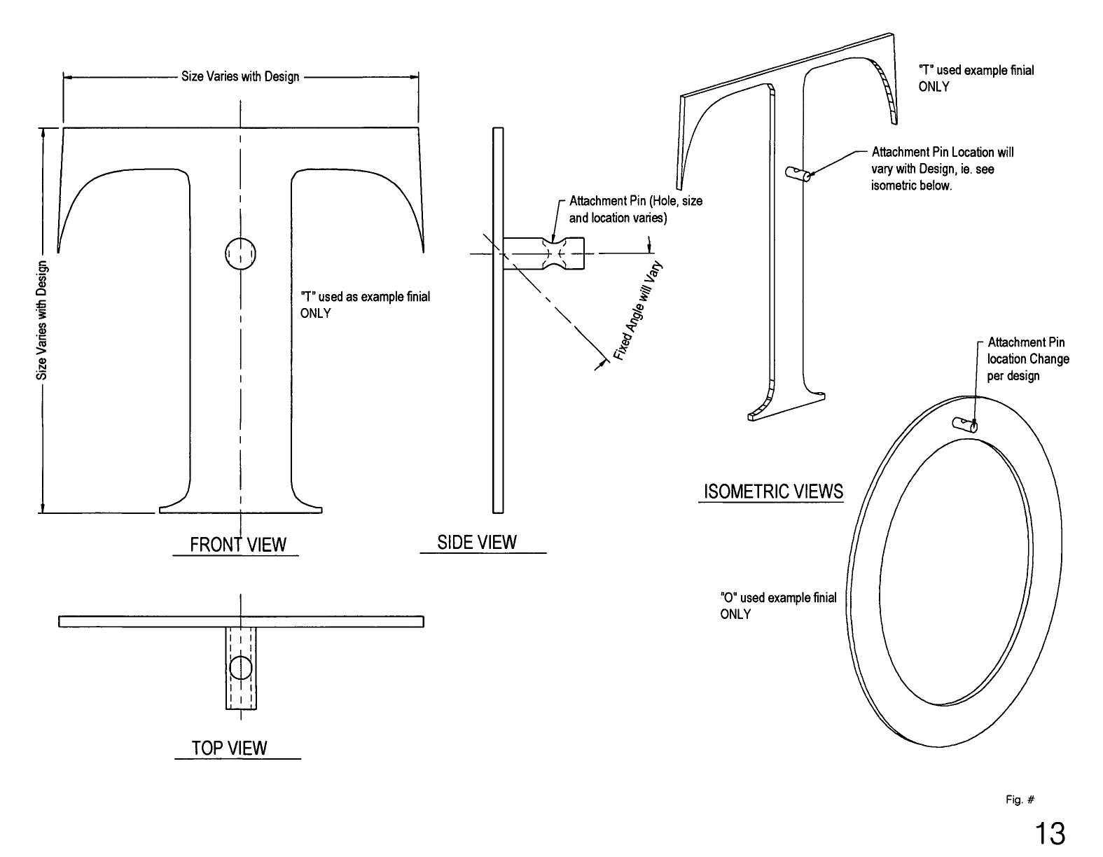

FIG. 2 is an exploded view of the three major components of the Decorative Finial Banner Display System, to illustrate the assembly process. This perspective includes the vertical surface bracket as shown in FIG. 7, 8, 9, 10, the banner rod tube, as shown in FIG. 11, 12 and the decorative finial as shown in FIG. 13.

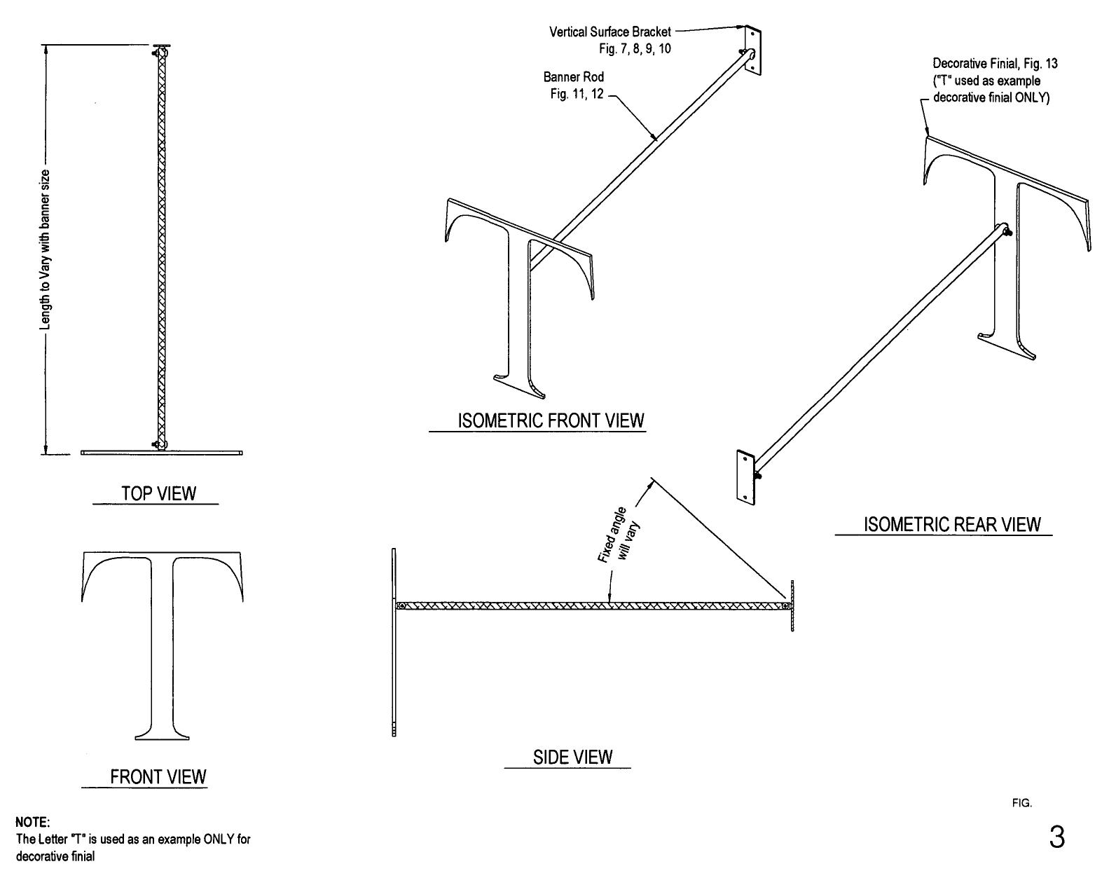

FIG. 3 is a schematic view of the Decorative Finial Banner Display System, in the single banner option. This perspective includes views of the vertical surface bracket (FIG. 7, 8, 9, 10), the banner rod tube (FIG. 11, 12) and the decorative finial (FIG. 13).

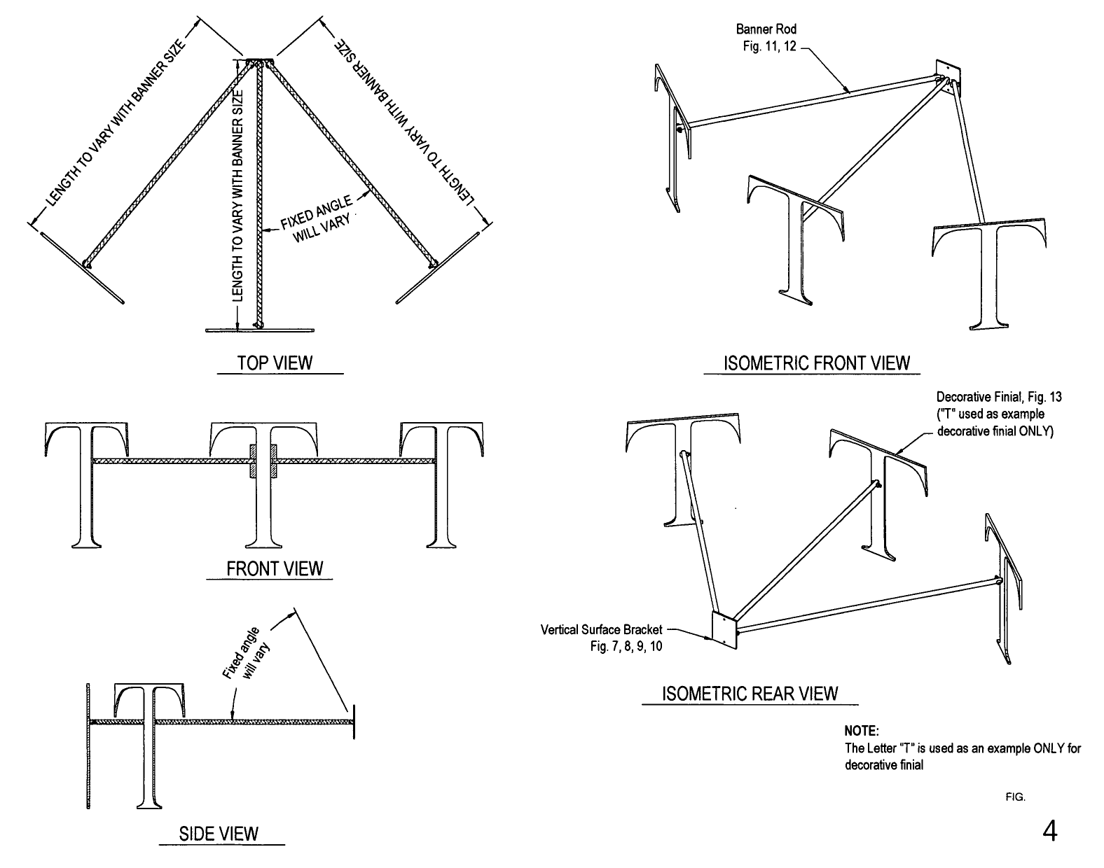

FIG. 4 is a schematic view of the Decorative finial Banner Display System, in the multiple banner option. This perspective includes views of the vertical surface bracket (FIG. 7, 8, 9,1 10), the banner rod tube (FIG. 11, 12) and the decorative finial (FIG. 13).

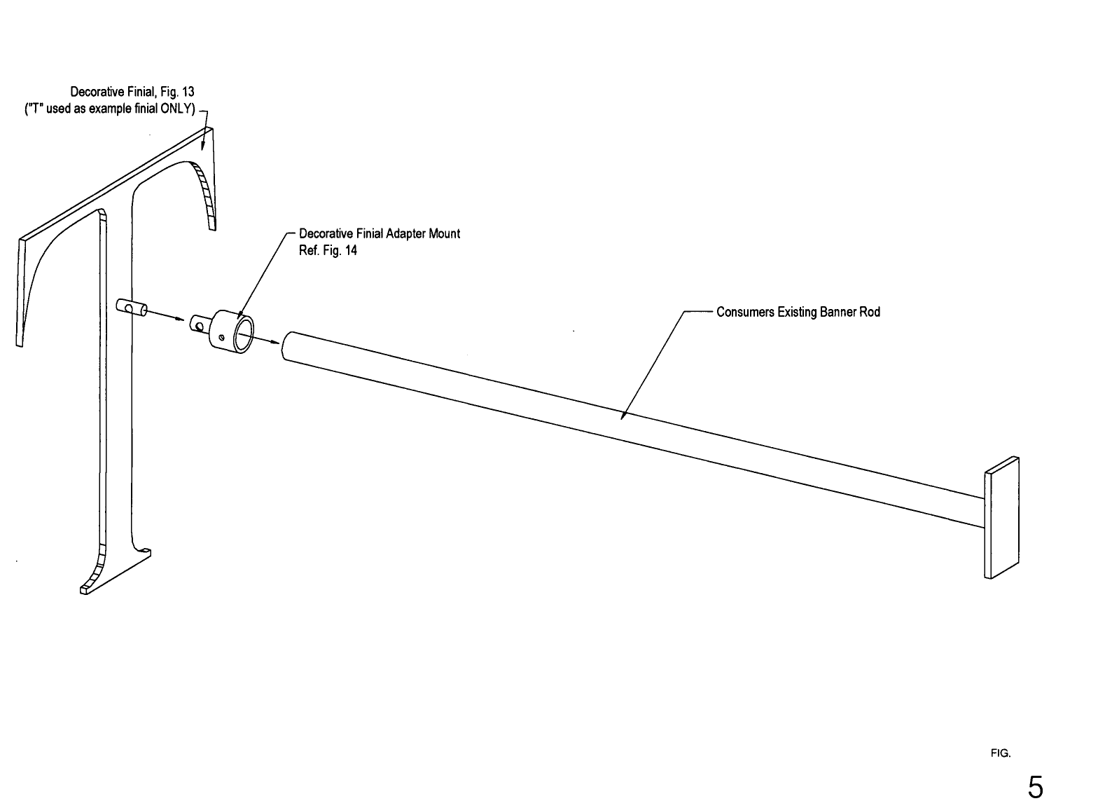

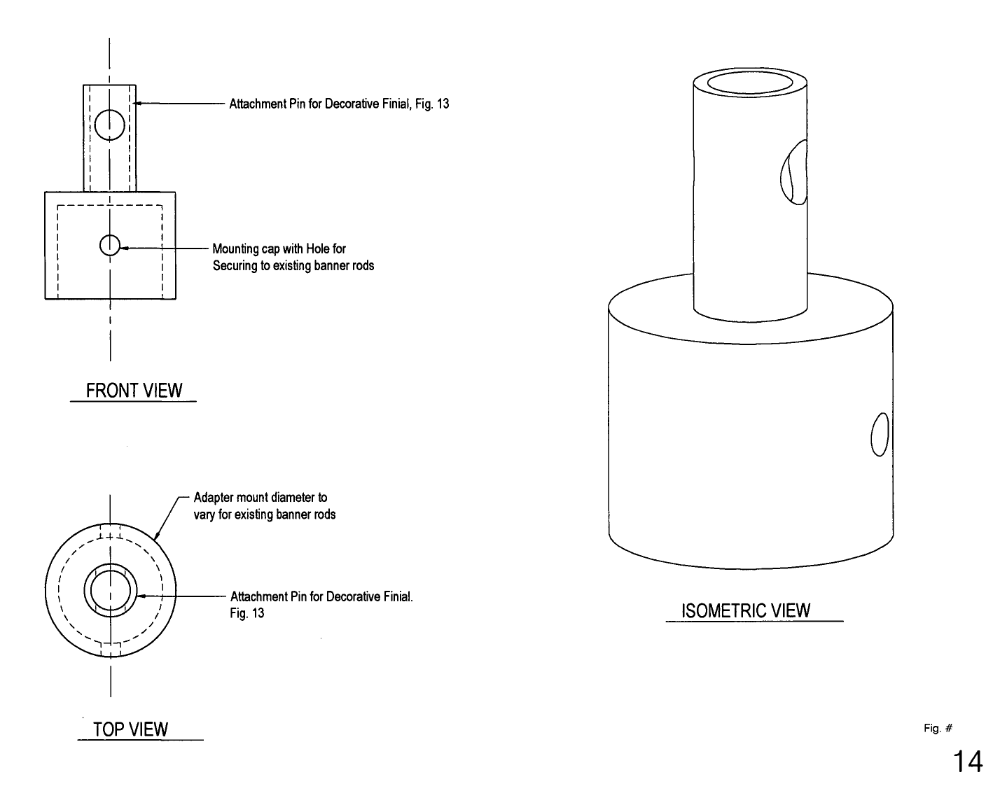

FIG. 5 is an overview, showing how the decorative finial (FIG. 13) can be used with a consumers existing dowel/banner rod, by attaching the decorative finial (FIG. 13) with the decorative finial adapter mount (FIG. 14).

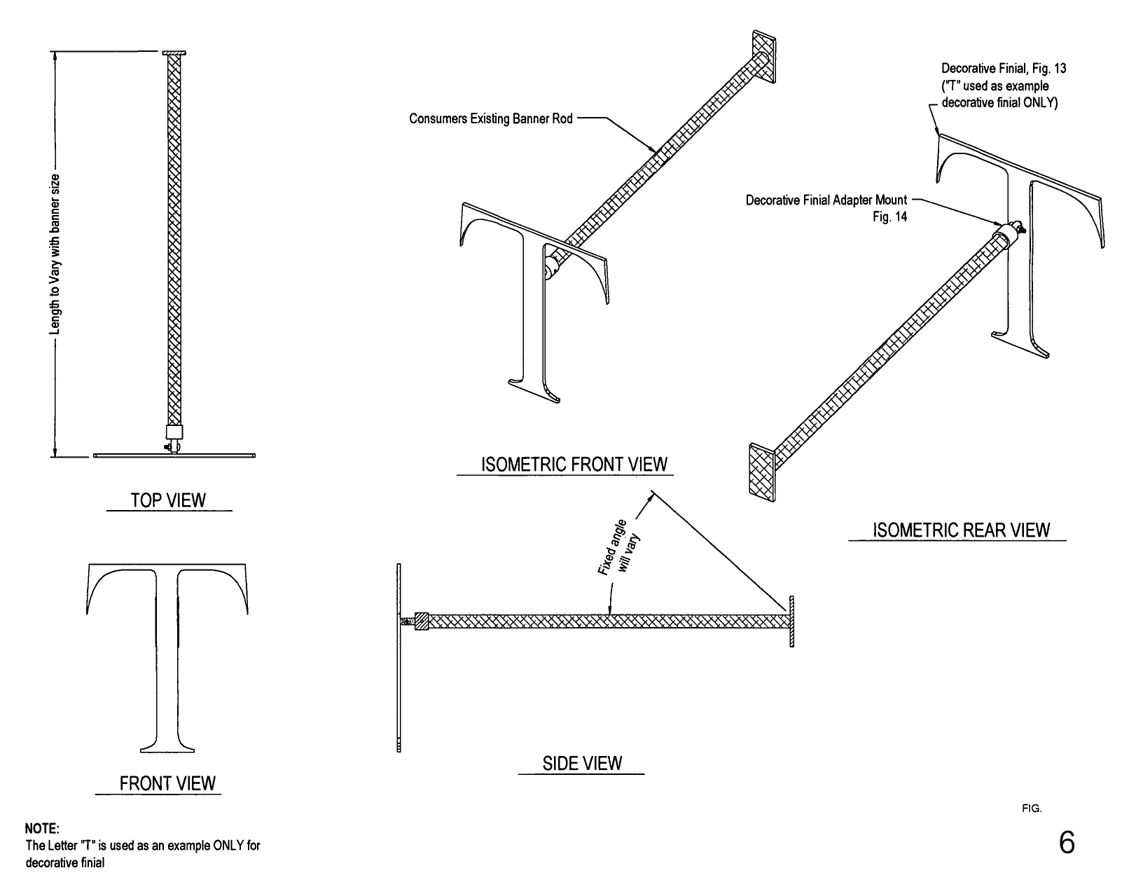

FIG. 6 is a schematic view of the decorative finial (FIG. 13) and the decorative finial adapter mount (FIG. 14) when used with the consumers existing dowel/banner rod.

FIG. 7 Vertical Surface Bracket with Mounting Holes: A bracket that mounts to a vertical surface by means of inserting screws, bolts, etc. through the holes of the bracket to secure it in place. The length, width and height of the bracket will be determined by the size and weight of the banner and Decorative Finial. For instance, the home consumer may use the standard size banner where a sports venue display may be considerably larger in size and weight, requiring a larger bracket and sturdy hardware for securing in place.

The attachment pin on the Vertical Surface Bracket is for attaching the Banner Rod Tube (ref. FIG. 11, 12). The attachment pin may have a single hole for the use of a spring button as a means of securing the Banner Rod Tube or it may have a thru hole for use of a standard bolt, barrel bolt, double spring button or like hardware. Construction materials, size and weight will dictate the attachment pin's overall dimension and fixed angle at final construction.

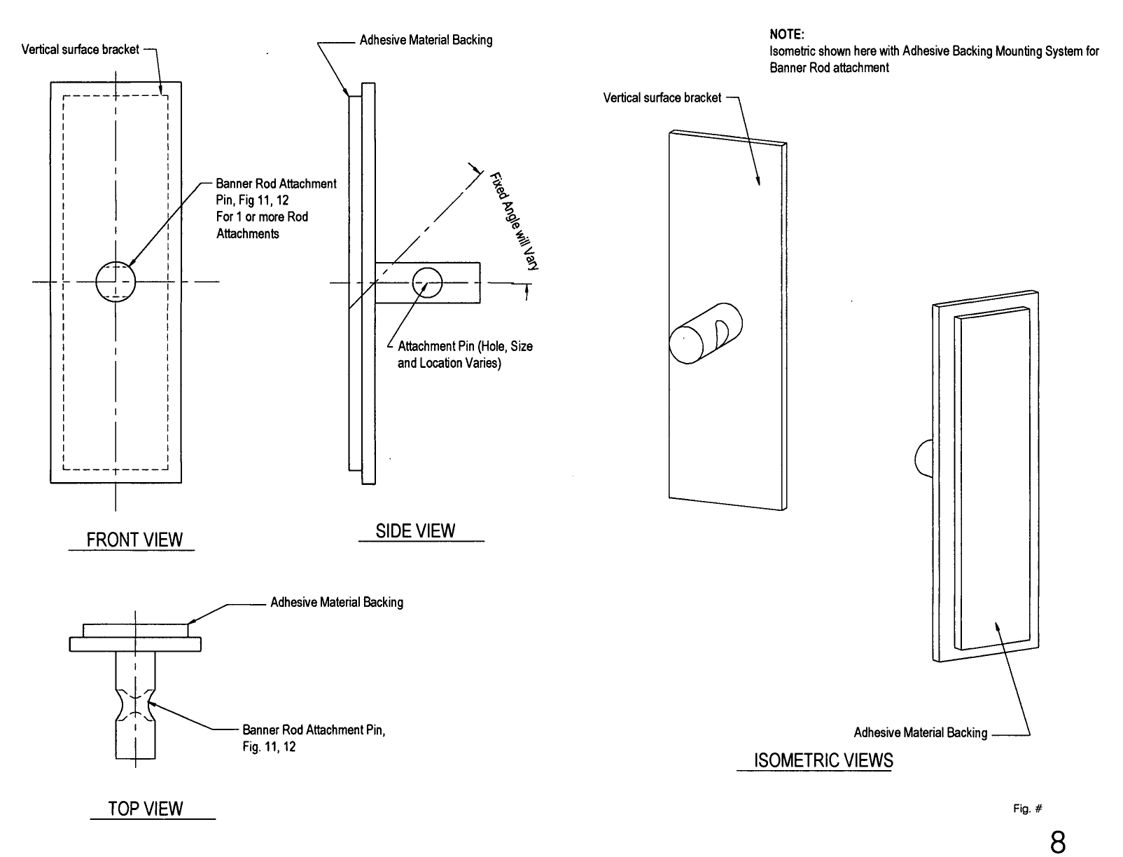

FIG. 8 Vertical Surface Bracket with Adhesive Material Backing: A bracket that mounts to a vertical surface by means of a very high bond adhesive backing to secure it in place. Preferred uses for this bracket would be RV's for tailgating, boats and automobiles (such as trucks with toppers) where using the Vertical Surface Bracket with Holes (ref FIG. 7) is NOT preferred. The display system, however, is NOT RECOMMENDED FOR VEHICLES IN MOTION. The length, width, height and amount of Adhesive Material comprising the bracket will be determined by the size and weight of the banner and Decorative Finial.

The attachment pin on the Vertical Surface Bracket is for attaching the Banner Rod Tube (ref. FIG. 11, 12). The attachment pin may have a single hole for the use of a spring button as a means of securing the Banner Rod Tube or it may have a thru hole for use of a standard bolt, barrel bolt, double spring button or like hardware. Construction materials, size and weight will dictate the overall dimensions and fixed angle of attachment pin at final construction.

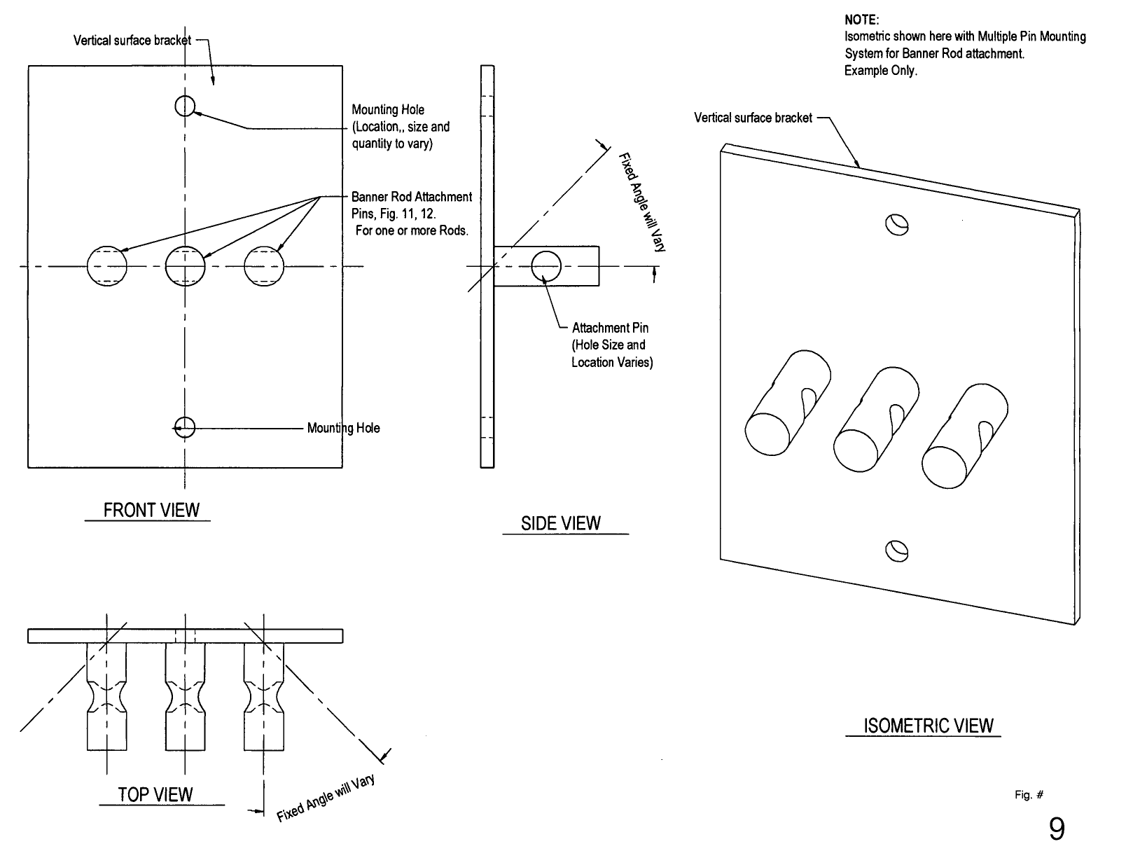

FIG. 9 Vertical Surface Bracket with Mounting Holes and Multiple Attachment Pins: A bracket that mounts to a vertical surface by means of inserting screws, bolts, etc. through the holes of the bracket to secure it in place. The length, width and height of the bracket will be determined by the size, weight and number of banners and Decorative Finials. For instance, the home consumer may use the standard size banner where a sports venue display may be considerably larger in size and weight, requiring a larger bracket and additional hardware for securing in place.

The multiple attachment pins on the Vertical Surface Bracket is for attaching the Banner Rod Tubes (ref. FIG. 11, 12). The attachment pins may have a single hole for the use of a spring button as a means of securing the Banner Rod Tube or it may have a thru hole for use of a standard bolt, barrel bolt, double spring button or like hardware. Construction materials, size and weight will dictate the attachment pin's overall dimensions and fixed angles at final construction.

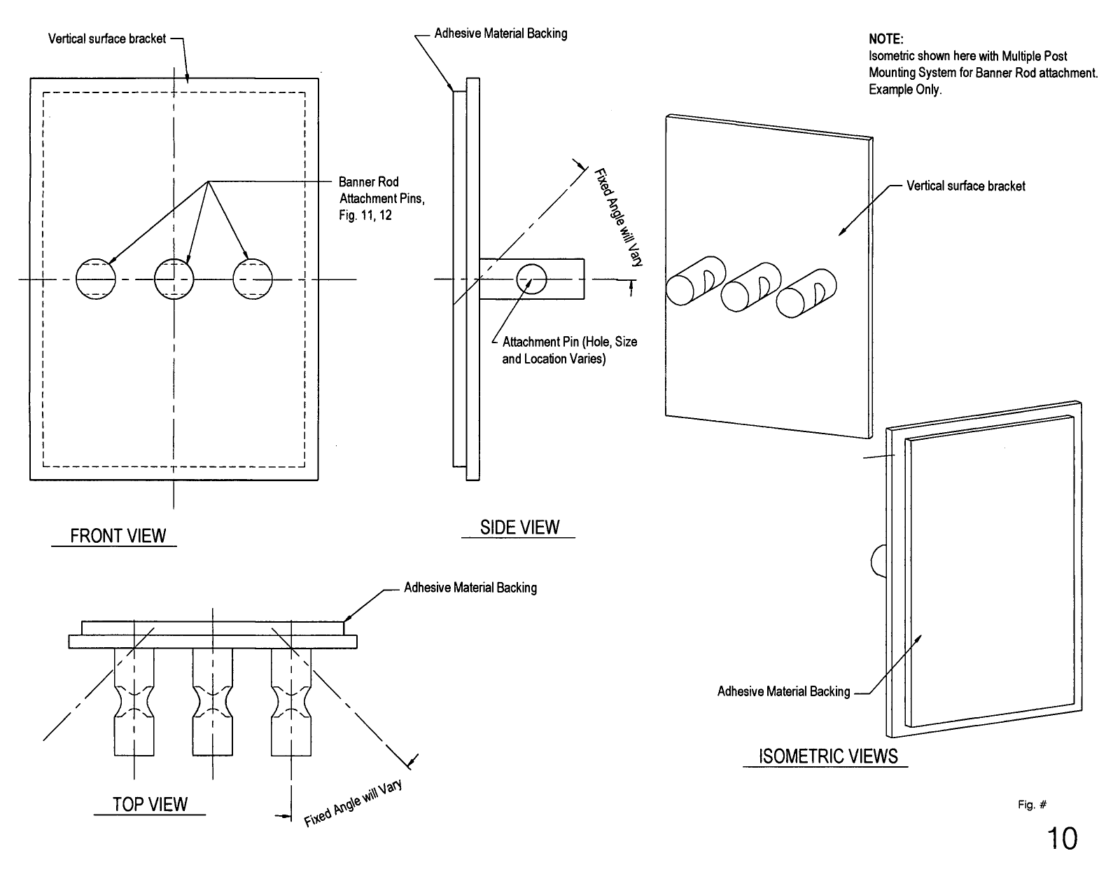

FIG. 10 Vertical Surface Bracket with Adhesive Material Backing and Multiple Attachment Pins: A bracket that mounts to a vertical surface by means of a very high bond adhesive backing to secure it in place. Preferred uses for this bracket would be RV's for tailgating, boats, and automobiles (such as trucks with toppers) where using the Vertical Surface Brackets with Holes (ref FIG. 7) is NOT preferred. The display system, however, is NOT RECOMMENDED FOR VEHICLES IN MOTION. The length, width, height and amount of Adhesive Material comprising the bracket will be determined by the size and weight of the banners and Decorative Finials.

The attachment pins on the Vertical Surface Bracket is for attaching the Banner Rod Tube (ref. FIG. 11, 12). The attachment pins may have a single hole for the use of a spring button as a means of securing the Banner Rod Tube or it may have a thru hole for use of a standard bolt, barrel bolt, double spring buttons or like hardware. Construction materials, size and weight will dictate the attachment pin's overall dimensions, amount of Adhesive Material and fixed angles at final construction.

FIG. 11 Banner Rod Tube: This is a single piece rod or tube that connects the Vertical Surface Bracket Attachment Pin (ref. FIG. 7, 9) to the Decorative Finials' Attachment Pin (ref. FIG. 13), creating a complete system to display a banner and Decorative Finial. The rod or tube will have a single or double hole at either end for securing the various parts together by means of a standard bolt, barrel bolt or one or more spring buttons, or like hardware.

The outside dimension of rod or tube will vary with construction materials used and the overall size and weight of the banner and Decorative Finial. Likewise, securing hardware will vary for the same reasons.

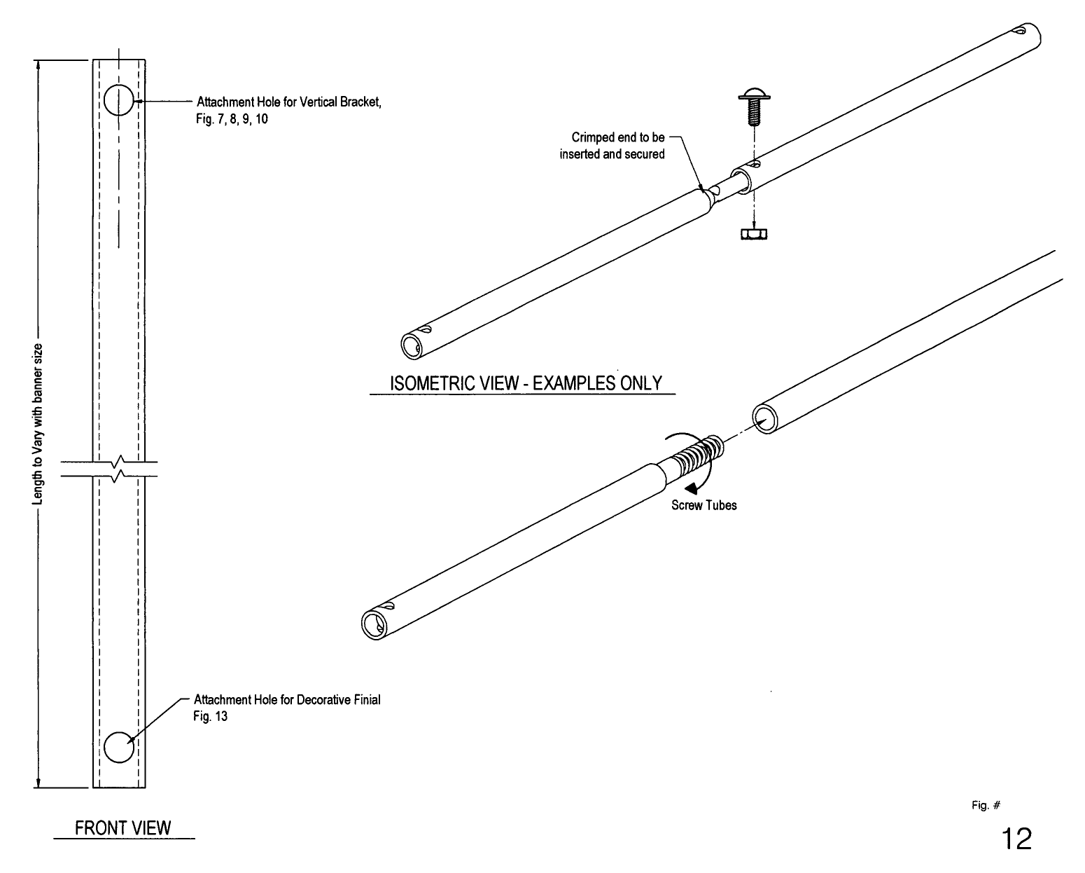

FIG. 12 Multi Piece Banner Rod Tube: For purposes of packaging, shipping or storage, the Banner Rod Tube can be comprised of multiple (two or more) pieces which can connect to make a standard size Banner Rod Tube to mount to Decorative Finial (ref. FIG. 13) on one end and the Vertical Surface Bracket (ref. FIG. 11, 12) on the other end, creating a complete system to display a banner and Decorative Finial. The rod or tube that comprise the multi piece Banner Rod Tube will have a single or double hole at either end for securing the various parts together by means of a standard bolt, barrel bolt or one or more spring buttons, or like hardware.

The outside dimension of the Banner Rod Tube and means of joining the separate part will vary with construction materials used and the overall size and weight of the banner and Decorative Finial. Likewise, securing hardware will vary for the same reasons.

FIG. 13 Decorative Finial: The Decorative Finial is the ornamental front facing cap feature of the Decorative Finial Banner Rod System. The overall dimensions of the Decorative Finial can vary depending on final artwork. The Attachment Pin on the Decorative Finial is for attaching to the Banner Rod (ref. FIG. 11, 12). It may have a single hole for the use of a spring button as a means of securing the banner rod or it may have a thru hole for use of a standard bolt, barrel bolt, two spring buttons or like hardware. Construction materials, size and weight of Decorative Finial will dictate the overall dimension, hole size and fixed angle of Attachment Pin at final construction.

FIG. 14 Decorative Finial Adapter Mount: The Decorative Finial Adapter Mount is a device that connects the Decorative Finial to the consumers existing dowel rod. The inside dimensions of the mounting cap will vary for the variety of dimensions of existing dowel rods. The mounting cap is equipped with two holes for securing to a dowel rod by means of thru bolting or 1-2 screws.

The Mounting Cap is topped with an Attachment Pin for connecting to the Attachment Pin located on the back of the Decorative Finial (ref. FIG. 13). The Attachment Pin may have a single hole for the use of a spring button as a means of securing the Decorative Finial to the Decorative Finial Adapter Mount or it may have a thru hole for use of a standard bolt, barrel bolt or even two spring buttons or like hardware. Construction materials, existing dowel rod dimensions, size and weight of banner and Decorative Finial will dictate the overall dimensions at final construction.

Having described the invention, we claim:

1. A Decorative Finial Banner Display System for mounting a decorative finial to a banner rod that attaches to a mounting bracket on a horizontal or above plane that has been secured to a support structure such as a wall or pole and most vertical surfaces.

2. The Decorative Finial Banner Display System of claim 1, wherein the decorative finial has a banner rod attachment pin on opposite side of decorative surface for securing said decorative finial to banner rod.

3. The Decorative Finial Banner Display System of claim 2, wherein banner rod has socket ends for receiving the banner rod attachment pin located on the opposite side of the decorative surface of the decorative finial.

4. The Decorative Finial Banner Display System of claim 1, wherein said banner rod with socket end secures to a mounting bracket with one or more banner rod attachment pins.

5. The Decorative Finial Banner Display System of claim 4, wherein mounting bracket with one or more banner rod attachment pins are located on opposite side of bracket mounting surface.

6. The Decorative Finial Banner Display System of claim 5, wherein the mounting bracket with one or more banner rod attachment pins opposite side of the bracket mounting surface may secure to most vertical surfaces by mechanical means.

7. The Decorative Finial Banner Display System of claim 5, wherein mounting bracket with one or more banner rod attachment pins opposite side of the bracket mounting surface may secure to most vertical surfaces by means of very high bond adhesive.

8. The Decorative Finial Banner Display System decorative finial adapter mount connects to most consumer's existing banner poles, to display said decorative finials.

9. the Decorative Finial Banner Display System of claim 8, wherein decorative finial adapter mount has a socket end with thru hole for receiving most consumer's existing banner poles and attaching mechanically via the thru hole.

10. Decorative Finial Banner Display System of claim 8, wherein the decorative finial adapter mount has socket opposite of banner pole to receive decorative finial attachment pin.

11. The Decorative Finial Banner Display System of claim 10, wherein decorative finial with attachment pin opposite of decorative surface is received by socket of said decorative finial adapter mount opposite the end of the consumer's existing banner pole.
